(19) United States
(12) Patent Application Publication
(10) Pub. No.: US 2016/0144360 A1
(43) Pub. Date: May 26, 2016

(54) MICROPLATE HAVING REGIONS OF DIFFERENT THICKNESSES

(71) Applicant: Corning Incorporated, Corning, NY (US)

(72) Inventors: William Joseph Lacey, North Andover, MA (US); Paul Michael Szlosek, Kennebunk, ME (US); Allison Jean Tanner, Portsmouth, NH (US); Joseph Christopher Wall, Southborough, MA (US); Kathy Marie Youngbear, Cambridge, MA (US)

(21) Appl. No.: 14/950,481

(22) Filed: Nov. 24, 2015

Related U.S. Application Data
(60) Provisional application No. 62/083,357, filed on Nov. 24, 2014.

(51) Int. Cl. B01L 3/00; B29C 51/00; B29C 51/10; B29C 45/00; B29C 51/42

(52) U.S. Cl. CPC B01L 3/50851; B29C 45/0001; B29C 51/428; B29C 51/10; B29C 51/002; B01L 2300/0829; B01L 2200/12; B01L 2300/12; B29K 2023/12

(57) ABSTRACT

A method of forming microplate includes forming a preform microplate including a deck and a plurality of wells, and reforming at least one well of the plurality of wells to provide a microplate. Each well of the plurality of wells in the preform microplate has a first depth and a first wall thickness. At least one well of the microplate has a second depth and a second wall thickness, where the second depth is greater than the first depth and/or the second wall thickness is less than the first wall thickness.

This application claims the benefit of priority under 35 U.S.C. §119 of U.S. Provisional Application Serial No. 62/083,357 filed on Nov. 24, 2014 the content of which is relied upon and incorporated herein by reference in its entirety.

### BACKGROUND

1. Field

The present disclosure relates generally to microtiter plates, also known as microplates, and more particularly to microplates having regions of different thicknesses and their methods of manufacture. The microplates having regions of different thicknesses are adapted for use with automated equipment and can withstand thermal cycling with reduced deformation, while providing improved heat transfer.

2. Technical Background

Polymerase chain reaction (“PCR”) processes involve the replication and amplification of genetic material such as DNA and RNA. During this process, segments of DNA are placed in an array of wells sealed at the top by tape or a plug for each well. The array of wells is then placed into the heating and cooling block of the thermocycler to start the reaction. The sample can be heated and cooled in very precise and rapid steps in a thermocycling process to create multiple copies of the DNA, thus amplifying the DNA segment in the well. During this thermocycling process, the well plate will see a temperature as high as about 95-100° C.

Because of their ease of handling and relatively low cost, multi-well microplates are often used for sample containment during the PCR process in both industry and academic research. The wells in the microplates can be formatted into 8 well strips or 96, 384, or 1536 well arrays as well as higher and lower densities of wells. The 96 well microplate is one of the most common formats for PCR. The wells of the microplate are often connected by a planar deck, which is typically located at the well openings. Microplates may also be used in other research and clinical diagnostic procedures.

A common microplate material is polypropylene, which has few extractables to interfere with DNA or other biological samples or the PCR process. Due to the low working temperature of polypropylene, however, this material can move or become distorted or deformed during or after the thermocycling process. Deformation may, for example, include warping, twisting, or other deviations of the planar deck from the original conformation. The deformation may interfere with the removal of the strip or microplate from the thermocycling block following the thermocycling process, as deformation from the original planar conformation can result in changes in the overall dimension of the microplate, i.e., perpendicular to the original plane. The microplate can become stuck in the PCR thermocycling block due to the deformation. The deformation of the microplate can also be a problem if robotic grippers are used to handle the microplate after the thermocycling process.

In order to address the problem of deformation, it may be desirable to use microplates having a thick deck, which may better maintain planar fidelity, i.e., prevent or reduce deformation of the microplate during or after the thermocycling process.

However, traditionally, it is desired to have thin microplate well walls as this may provide increased thermal conductivity, which can result in faster heating and cooling cycle times. This is especially true for microplate wells made from a material having poor thermal conductivity, for example polymers such as polypropylene.

Traditionally, microplates are integrally formed (i.e., deck and wells are all one piece) and thus conventional molding techniques require that the entire microplate including the deck and wells be the same thickness. Consequently, the thickness of the microplate is traditionally chosen to maintain a degree of balance between good thermal conductivity of the wells and planar fidelity of the deck. Thus, some degree of either or both good thermal conductivity of the wells and planar fidelity of the deck is compromised.

Accordingly, there is a need for a microplate free of the aforementioned shortcomings.

### BRIEF SUMMARY

In accordance with embodiments of the present disclosure, a microplate is provided having regions of different thicknesses. As disclosed in various embodiments, the microplate may include a deck having a deck thickness and a plurality of wells, each well having a wall thickness. At least one well has a region of wall thickness that is less than the deck thickness. In some embodiments, the deck and the plurality of wells are integrally formed. The microplate, including the wells and deck, may be formed from a relatively non-rigid material such as polypropylene. The thicker deck enhances the rigidity of the microplate and decreases the strain impact of the thermally-induced stresses. The thinner well walls provide increased thermal conductivity. In some embodiments, the microplate is a PCR plate.

Also disclosed are methods of forming a microplate, including providing or forming a preform microplate having a deck and a plurality of wells, and reforming at least one well of the plurality of wells to provide a microplate. Each well of the plurality of wells in the preform microplate has a first depth and a first wall thickness. At least one well of the microplate has a second depth and a second wall thickness, where the second depth is greater than the first depth and/or the second wall thickness is less than the first wall thickness.

Additional features and advantages of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure, and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIGS. 1A-1C respectively illustrate a perspective view, a cut-away partial perspective view, and a cross-sectional side view of a microplate;

FIG. 2 is a perspective view of an exemplary thermocycler capable of heating and cooling exemplary microplates disclosed herein;

FIG. 3 is a schematic view of a preform microplate according to exemplary embodiments;

FIG. 4 is a schematic view showing an exemplary preform microplate in a cavity block with core pins;

FIG. 5 is a cutaway view of the embodiment of FIG. 4 showing the exemplary preform microplate in a cavity block with core pins;

FIG. 6 is a cutaway view of the embodiment of FIG. 4 showing the microplate being reformed in a cavity block with core pins;

FIG. 7 is a schematic view of a microplate having regions of different thicknesses according to exemplary embodiments of the disclosure; and

FIG. 8 is a cutaway schematic view of a well of the exemplary microplate shown in FIG. 7.

### DETAILED DESCRIPTION

Reference will now be made in greater detail to various embodiments of the subject matter of the present disclosure, some embodiments of which are illustrated in the accompanying drawings. The same reference numerals will be used throughout the drawings to refer to the same or similar parts.

According to various embodiments of the disclosure, microplates having regions of different thicknesses are disclosed. In various embodiments, a microplate comprises a deck having a deck thickness and a plurality of wells, each well having a wall thickness, wherein at least one well has a wall thickness that is less than the deck thickness.

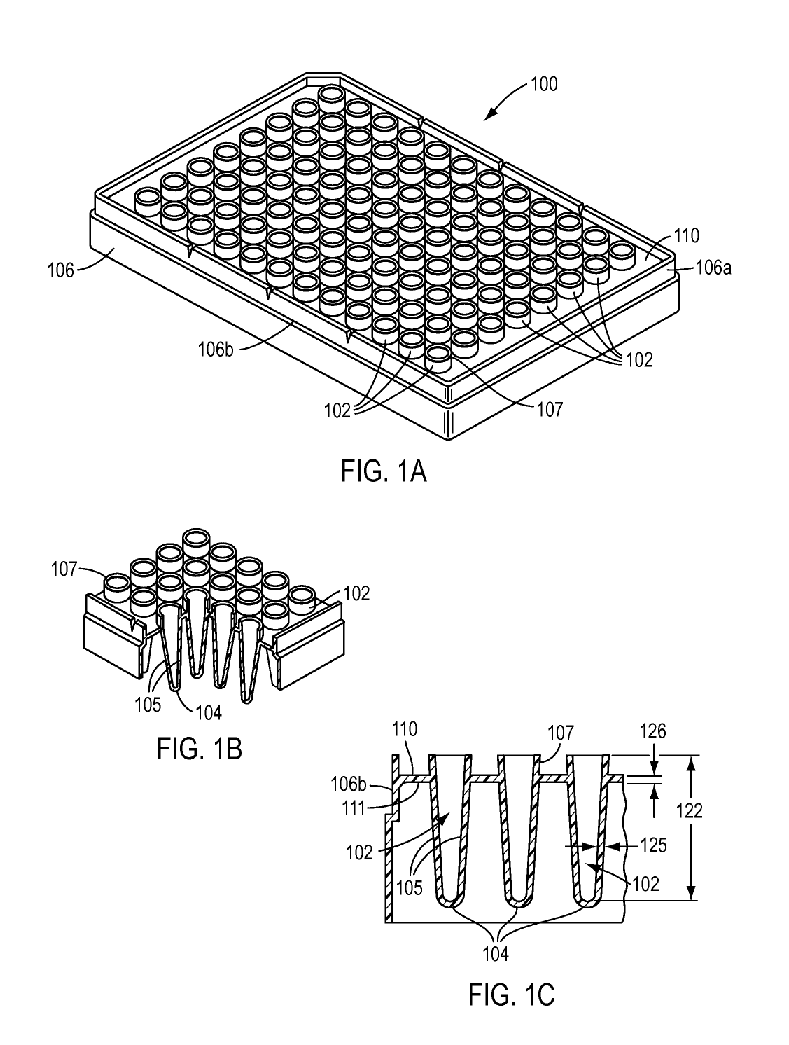

FIGS. 1A-1C illustrate different views of an exemplary microplate 100. The microplate 100 includes a deck 106 and a plurality of wells 102. According to various embodiments, microplate 100 may have well walls 105 and/or well bottoms 104 that are thinner than the thickness of the deck 106. In various embodiments, the microplates 100 having regions of different thickness may comprise a deck 106 and wells 102 that are integrally formed.

Thinner well walls 105 and/or well bottoms 104 may allow for improved thermal conductivity, while a thicker deck 106 may aid in resisting or reducing undesired deformation. As such, the use of a microplate having regions of different thicknesses may facilitate handling of the microplate by a scientist or robotic handling system, for example to remove the microplate from the thermocycler after completion of a PCR process.

As shown in FIG. 1C, a microplate 100 according to one embodiment includes a deck 106 having a top planar surface 110 and a bottom planar surface 111, defining a deck thickness 126, and a plurality of wells 102 formed in the deck, each well of the plurality of wells having a well depth 122 and a well wall 105 having a wall thickness 125. According to various embodiments of the disclosure, at least one well 102 of the plurality of wells has a wall thickness 125 that is less than the deck thickness 126. In further embodiments, all wells 102 have a wall thickness 125 that is less than the deck thickness 126.

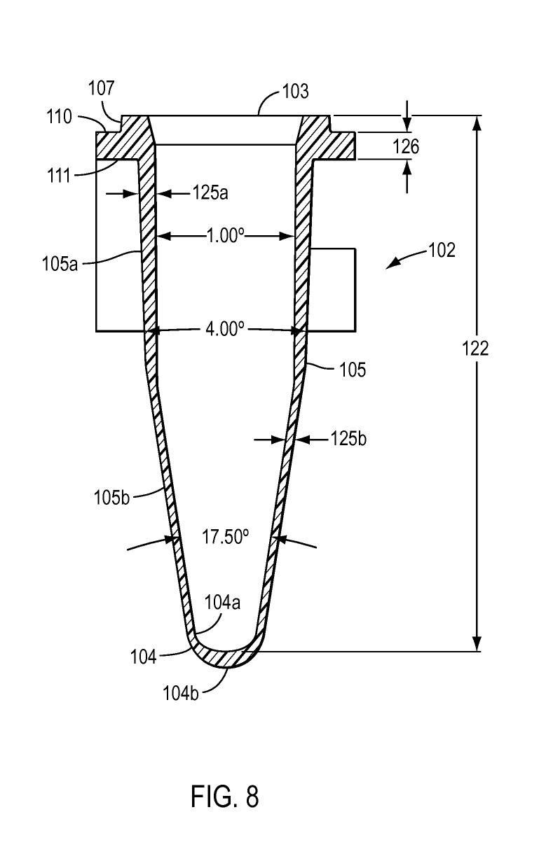

According to various embodiments, the wall thickness 125 may be variable over the well depth 122. In some embodiments, for example as shown in FIG. 8, the wall thickness 125 may be greater, i.e. the wall may be thicker in a region adjacent a well opening 103, and the wall thickness 125 may decrease, i.e. the wall may become thinner in a direction toward the well bottom 104. In further embodiments, the wall thickness 125 is greater in a region adjacent the well opening 103, decreasing in a direction toward the well bottom 104, and then increasing, i.e. becoming thicker in a region adjacent the well bottom 104. In various exemplary embodiments, the wall thickness 125 may monotonically decrease in a direction from the well opening 103 toward the well bottom 104 over at least a region of the well depth 122.

In yet further embodiments, the wall thickness 125 may be uniform or substantially uniform over the entire depth of the well, yet may still be less than a thickness of at least one other region of the microplate, e.g. may still be less than the deck thickness 126.

As seen in FIG. 8, according to various exemplary embodiments the well wall 105 may have an upper thickness in an upper region 105a adjacent the well opening 103, and a lower thickness in a lower region 105b adjacent the well bottom 104. In some embodiments, the upper wall thickness 125a is uniform or substantially uniform through the entire length of the upper region 105a. In other embodiments, the upper wall thickness 125a is variable through the upper region 105a. In some embodiments, the lower wall thickness 125b is uniform or substantially uniform through the entire length of the lower region 105b. In other embodiments, the lower wall thickness 125b is variable through the lower region 105b. In further exemplary embodiments, at least a portion of the upper region 105a has a greater wall thickness 125a than the wall thickness 125b of at least part of the lower region 105b. In certain embodiments, the wall thickness 125a of the entire upper region 105a is greater than the wall thickness 125b of the lower region 105b.

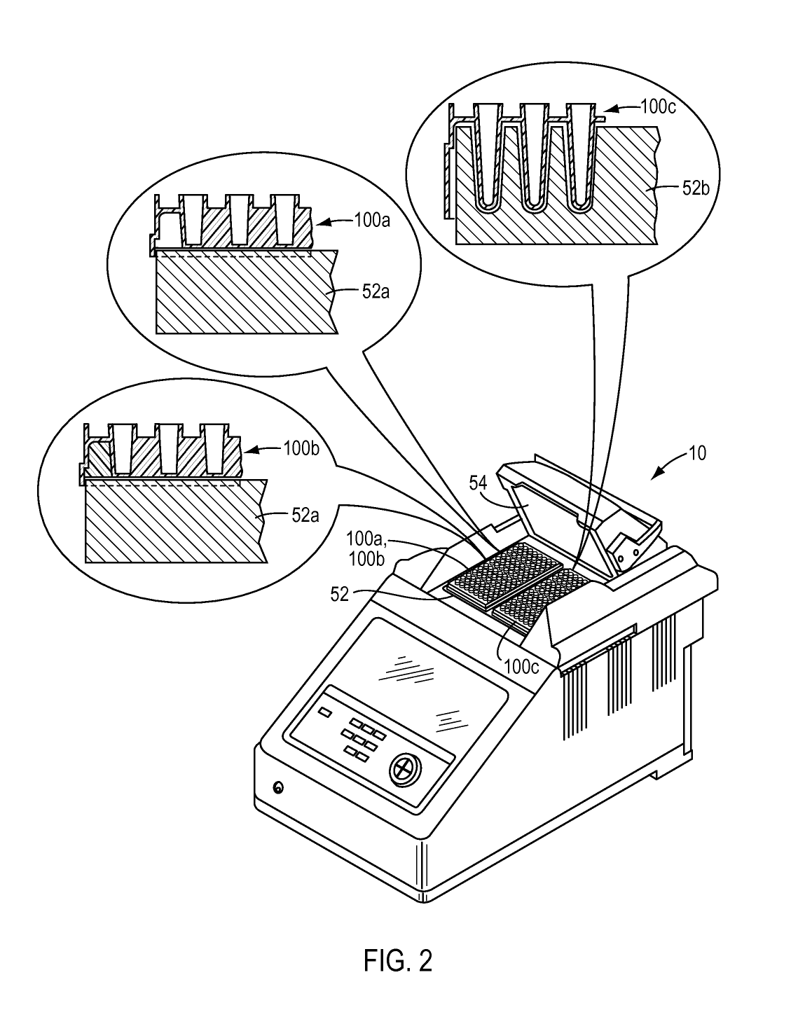

In various embodiments, the microplate 100 is configured to be placed within a thermocycler 10 as shown in FIG. 2, which is a perspective view of an exemplary thermocycler 10 capable of heating and cooling at least one microplate 100a, 100b, or 100c. Again with reference to FIG. 8, in various embodiments a region of at least one well 102 may be configured to be inserted into a heating block of a thermocycler. As such, in various embodiments, the well wall 105 of the region of the well configured to be inserted into the heating block may have a thickness that is less than a wall thickness 125 of a different region of the well that is not configured to be inserted into the heating block. For example, the lower region 105b may be configured to be inserted into a heating block of a thermocycler, and the lower region 105b may have a wall thickness 125b that is less than the wall thickness 125a of the upper region 105a, which may not be configured to be inserted into the heating block

In various embodiments, the wall thickness 125 may be variable over at least one cross-section of a well 102 taken substantially parallel to the plane of the top surface 110 of the deck 106. In some embodiments, the variability in wall thickness 125 over at least one cross-section of the well 102 results in an inner surface of the well wall 105 having a different shape than the outer surface of the well wall 105. In some embodiments, the variability in wall thickness 125 over at least one cross-section of the well 102 results in a localized area of wall thickness 125, which may, for example, be in the form of a protrusion from the inner surface of the well wall 105 into the well 102, and/or a protrusion from the outer surface of the well wall 105. In some embodiments, the variability in wall thickness 125 may occur over several cross-sections of the well 102 such that the localized area of wall thickness or protrusion forms a feature extending substantially perpendicular to the plane of the top surface 110 of the deck 106. In other embodiments, the wall thickness 125 may be uniform or substantially uniform over at least one cross-section of the well 102 taken substantially parallel to the plane of the top surface 110 of the deck 106.

As described herein, according to various exemplary and non-limiting embodiments, a region of a microplate deck has a thickness that is greater than a thickness of at least one region of one or more well walls of the microplate. In the embodiment shown in FIG. 8, the apron 106a may have a thickness 126a that is greater than the thickness 126 of the top planar surface of the deck 106. In at least certain embodiments, the deck thickness 126 is uniform or substantially uniform throughout the entire deck. In various embodiments, at least one region of the microplate deck 106 has a thickness 126 ranging from greater than about 1 to about 10 times the thickness 125 of at least one region of one or more well walls, such as, for example, from greater than about 1 to about 7 times, or from about 2 to about 6 times the thickness 125 of at least one region of one or more well walls. In the exemplary and non-limiting embodiment shown in FIG. 8, the deck thickness 126 is about 4 times the wall thickness 125 as measured at the thinnest point 125c of the well wall.

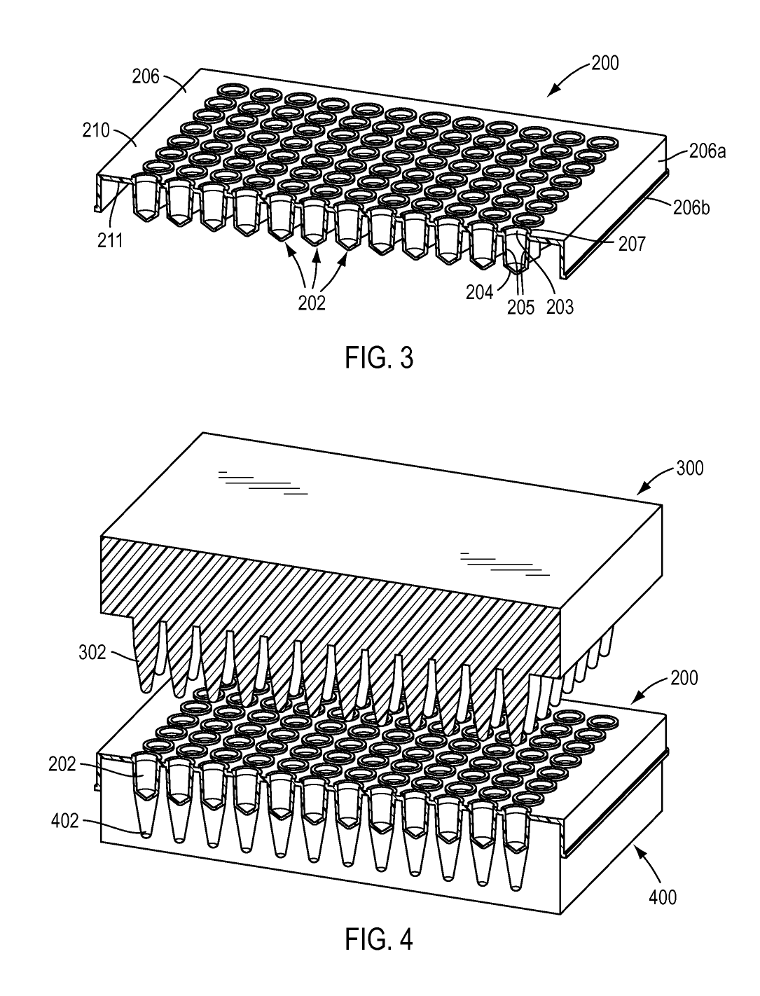

Methods of forming microplates having regions of different thicknesses are also disclosed, and are described herein with reference to the non-limiting examples shown in FIGS. 3-7. Exemplary methods include forming a preform microplate, and reforming the preform microplate. Other methods include providing a preform microplate and reforming the preform microplate.

Nonlimiting methods for forming a preform microplate 200 include injection molding, drawing by a plurality of core pins and a cavity block, stamping, and combinations thereof.

Nonlimiting methods for reforming a preform microplate 200 into a microplate 100 include drawing by a plurality of core pins and a cavity block, drawing by a plurality of core pins and a nest having clearance holes for the plurality of wells, blow molding, and combinations thereof. When reforming the microplate wells, the preform microplate may be transferred (e.g., in a circular manor or by a walking beam) to a deeper cavity.

With reference to FIGS. 3-7, exemplary methods of forming a microplate 100 include forming or otherwise providing a preform microplate 200 comprising a deck 206 and a plurality of wells 202, wherein one or more of the wells 202 of the plurality of wells have a first well depth 222 and a first well wall thickness 225, which may be the same or different for each well, and subsequently reforming at least one well 202 in the preform microplate 200 to provide a microplate 100 comprising a plurality of wells, wherein at least one well 102 has a second well depth 122 and a second well wall thickness 125. According to various embodiments, the second well depth 122 is greater than the first well depth 222, and/or the second well wall thickness 125 is less than the first well wall thickness 225. In at least one embodiment, the second well depth 122 is greater than the first well depth 222 and the second well wall thickness 125 is less than the first well wall thickness 225, such that the wells 102 of the microplate 100 are deeper and have thinner walls than the wells 202 of the preform microplate 200.

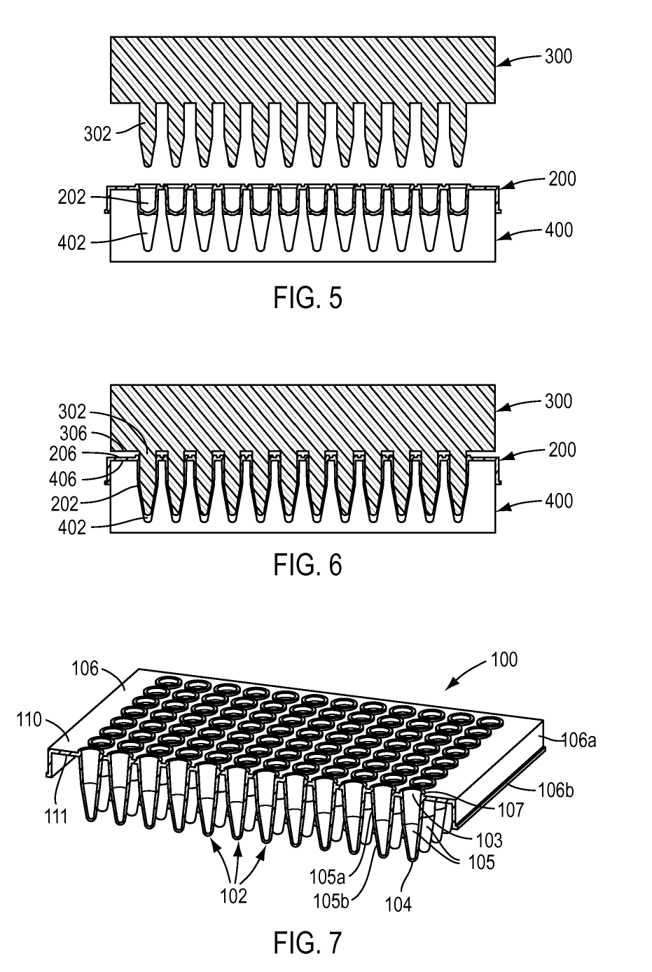

According to various embodiments, a cavity block 400 may be configured to receive a preform microplate 200 in such a manner that the deck 206 and wells 202 of the preform microplate 200 are suitably matched to the dimensions and shape of the cavity block 400 and the well cavities 402. In this way, the wells 202 of the preform microplate 200 and the well cavities 402 of the cavity block 400 may be engaged, i.e. at least one well 202 of the preform microplate 200 is positioned within a corresponding well cavity 402 of the cavity block 400. In the embodiment shown in FIGS. 4 and 5, each well 202 of the preform microplate 200 is positioned within a corresponding well cavity 402 of the cavity block 400 when the preform microplate 200 is engaged with the cavity block 400. In further embodiments, however, the preform microplate 200 may have fewer wells 202 than the cavity block 400 has cavities 402, such that not every well cavity 402 is engaged. In yet further embodiments, the preform microplate 200 may have a greater number of wells 202 than the cavity block 400 has cavities 402, such that not every well 202 is engaged.

Once the preform microplate 200 and cavity block 400 are engaged, pin block 300 may subsequently be brought into engagement therewith. In various embodiments, at least one core pin 302 engages a corresponding well 202 when the pin block 300 is brought into engagement with the cavity block 400. In some embodiments, this draws the material of at least one well 202 of the preform microplate 200 into a thinner and/or deeper well 102. In the embodiment shown in FIG. 6, for example, each core pin 302 enters a corresponding well 202 and cavity 402 when the pin block 300 is brought into engagement therewith.

In various embodiments, the preform microplate 200 comprises glass or a polymeric material, such as, for example, polycarbonate, polystyrene, polypropylene and cyclo-olefins, and combinations thereof. The polymeric material may be, in various embodiments, a liquid or solid polymer or polymer precursor. In some embodiments, the preform microplate 200 comprises the same material as the microplate 100. In various embodiments, additional material may be added to the preform microplate 200 during the reforming process. Such additional material may be the same material in some embodiments, or the additional material may be a different material in other embodiments. In an example embodiment, the wells 202 of the preform microplate 200 may comprise a combination of glass well bottoms 204 with polymeric well walls 205.

In various embodiments, reforming a preform microplate 200 includes a step of providing heat to the preform microplate 200. The heat may be provided using various techniques. For example, the heat may be provided by the use of a one or more heated core pins, a heated cavity block or heated nest, or by performing the reforming step with exposure to hot air.

In some embodiments, the rate and/or amount of heat provided may influence the wall thickness profile of the microplate 100. In some embodiments, the rate and/or amount of heat provided to the preform microplate 200 may be controlled by controlling the temperature and/or heating rate of equipment used in the reforming process, such as the core pins, cavity block, or nest, for example. In other embodiments, the rate of heating of the preform microplate 200 does not affect the wall thickness profile of the microplate 100.

In some embodiments, at least some portion of the material of the preform microplate remains solid during the reforming process. In other embodiments, at least some portion of the material of the preform microplate 200 undergoes a phase change during the reforming process. For example, in various embodiments, the preform microplate 200 includes a polymer material, which is heated above a glass transition temperature T_{g} of the polymer material during the reforming process, or is heated above a glass transition temperature T_{g} of the polymer material but below a melting temperature Tₘ of the polymer material during the reforming process. In other embodiments, the preform microplate 200 includes a polymer material that is heated above a glass transition temperature T_{g} of the polymer material and above a melting temperature Tₘ of the polymer material during the reforming process.

In the exemplary embodiment illustrated in FIGS. 4-6, the preform microplate 200 is reformed using a pin block 300 having a plurality of pins 302 and a cavity block 400 having a plurality of well cavities 402. In the exemplary embodiment shown, the cavity block 400 and well cavities 402 are configured to receive the preform microplate 200 in such a manner to engage therewith. The preform microplate 200 is engaged with the cavity block 400 and is reformed into the microplate 100 when the pin block 300 is brought adjacent the cavity block 400 such that one or more pins 302 of the pin block 300 engage one or more wells 202 of the preform microplate 200 and cavities 402 of the cavity block 400.

As discussed above, the reforming may be performed with heating, such as by heated pins 302 or cavities 402. Thus, the engagement of the pins 302 with one or more wells 202 and cavities 402 may transfer heat to the well walls 205, causing the well walls 205 to become malleable and be reformed into a shape and/or dimension substantially corresponding to the shape and/or dimensions of the pins 302 and/or cavities 402.

In various embodiments, the pin block 300 includes a number of core pins 302 corresponding to the number of wells 202 in the preform microplate 200, and/or corresponding to the number of wells 102 in the microplate 100. In various embodiments, the core pins 302 have a size and/or shape that correspond, or substantially correspond, to the size and/or shape of an inner surface of the wells 102 of the microplate 100.

In various embodiments, the cavity block 400 includes a number of cavities 402 corresponding to the number of wells 202 in the preform microplate 200, and/or corresponding to the number of wells 102 in the microplate 100. In some embodiments, the well cavities 402 have a size and/or shape that correspond to the size and/or shape of an outer surface of the wells 102 of the microplate 100.

In some embodiments, the rate at which at least one well 202 is reformed into a corresponding well 102 can influence the wall thickness profile of the well 102. In some embodiments, the rate of reformation may be controlled by the rate of engagement of the equipment used in the reforming process, for example the rate at which the pin block 300 is brought into engagement with the cavity block 400. In other embodiments, the rate of reformation of the preform microplate 200 does not affect the wall thickness profile of the microplate 100.

In various embodiments, reforming a preform microplate 200 comprises a step of forming a vacuum. Thus, in some embodiments, at least one well cavity 402 includes a vent. In some embodiments, the vent may be connected to vacuum source.

FIGS. 4 and 5 show an air space between the well bottom 204 and the well cavity 402. This air space may be removed during the engagement of the pin block 300 and the cavity block 400 by a vent in the well cavity 402 in various embodiments. In some embodiments, a vacuum is drawn at the vent in the well cavity 402 to facilitate removal of air from the air space during engagement of the pin block 300 and the cavity block 400.

FIG. 6 shows the pin block 300 pulling away from the microplate 100 after reformation has been achieved. In some embodiments, an air assist may be used to push the microplate 100 off the pin block 300 and/or out of the cavity block 400. In some embodiments, a vent in at least one of the core pins 302 may be used to apply air to push the microplate 100 off of the pin block 300. The vacuum formed in the vent in at least one well cavity 402 may be reversed to add air to push the microplate 100 out of the cavity block 400 in some embodiments. In some embodiments, the application of air would serve to cool the microplate 100 at the end of the reforming process and/or would allow removal of the microplate 100 with little distortion force. For example, the cavity block may include a valve such as a poppet value that enables the injection of air to eject the part from the well cavity.

In some embodiments, the rate of cooling of the microplate 100 can influence the wall thickness profile of the microplate 100. Optionally, the rate of cooling may be controlled by controlling the temperature of the equipment used in the reforming process, such as the pin block 300 and/or the cavity block 400. In other embodiments, the rate of cooling of the microplate 100 does not affect the wall thickness profile of the microplate 100.

In various embodiments, the deck 206 of the preform microplate 200 may optionally be reformed before, during, or after the reforming process. Alternatively, the deck 206 may optionally be reformed in a separate process. In some embodiments, the reforming of the deck 206 removes or reduces some defects, for example weak areas, knit lines, and/or pressure drops, in the deck 206. The removal or reduction of such defects can, at least in certain embodiments, result in a microplate having a more uniform strength. In some embodiments, the deck 206 of the preform microplate 200 is reformed by being coined or pressed between a bottom face 306 of the pin block 300 and a top face 406 of the cavity block 400 during or after the reforming of the wells 206. In other embodiments, the deck 206 is reformed using other equipment. In yet further embodiments, the deck 206 is not reformed.

In some embodiments, the reforming of the deck 206 includes forming a ridge 107 surrounding a periphery of at least one well opening 103. In some embodiments, the reforming of the deck includes removing a ridge 207 surrounding a periphery of at least one well opening 203 of the preform microplate. In some embodiments, the reforming of the deck includes reforming the ridge 207 surrounding the periphery of at least one well opening 203 into the ridge 107 surrounding the periphery of at least one well opening 103.

In various embodiments, the reforming process uses a pin block 300 and a nest having a plurality of well holes. Similar to the process illustrated in FIGS. 4-6, the nest having a plurality of well holes is configured to receive a preform microplate 200, and the pin block advances to engage the nest and reform at least one well 202 of the preform microplate 200. Optionally, the deck 206 may also be reformed during or after the reforming of the wells 202 by using the pin block and nest.

In some embodiments, reforming the preform microplate 200 provides a microplate 100 having dimensions (e.g., relative well wall and plate thicknesses) as well as lower residual stresses than could not otherwise be achievable using standard molding techniques. In some embodiments, coining or pressing the deck 206 during the reforming process can result in a deck 106 having low residual stress, which can further reduce the amount or magnitude of deformation observed during thermocycling. In some embodiments, the microplate 100 has lower internal stress than the preform microplate 200.

In various embodiments, at least one well wall 202 of the preform microplate 200 may have a first wall thickness 225 of at least about 20 mil, such as at least about 40 mil, or at least about 60 mil.

In various embodiments, the second well wall thickness 125 of the microplate 100 after the preform microplate 200 is reformed may be less than about 20 mil, such as less than about 15 mil, or less than about 10 mil. In some embodiments, the second well wall thickness 125 can range from about 0.007 inches to about 0.015 inches. In the embodiment shown in FIG. 8, for example, the second well wall thickness 125b of a lower region 105b of the well wall 105 of microplate 100 is about 0.011 inches, and the second wall thickness 125a of an upper region 105a of the well wall 105 of microplate 100 is about 0.025 inches.

In various embodiments, the second well wall thickness 125 of microplate 100 may be less than about 80% of the first well wall thickness 225, such as less than about 60%, less than about 40%, or less than about 20% of the first well wall thickness 225.

According to various embodiments, the well bottom 204 (FIG. 3) has a first bottom thickness 224, and the well bottom 104 (FIG. 7) has a second bottom thickness 124. In various embodiments, the second bottom thickness 124 may be less than the first bottom thickness 224. In various embodiments, the first bottom thickness 224 may be at least about 20 mil, such as at least about 40 mil, or at least about 60 mil. In various embodiments, the second bottom thickness 124 may be less than about 40 mil, such as less than about 30 mil, or less than about 20 mil. In some embodiments, the second bottom thickness 124 ranges from about 0.020 inches to about 0.030 inches. In the embodiment shown in FIG. 8, for example, the second bottom thickness 124 ranges from about 0.024 inches to about 0.025 inches.

In some exemplary and non-limiting embodiments, the preform microplate 200 may be formed to have a uniform or substantially uniform thickness, which may be substantially equivalent to the greatest thickness desired in the microplate 100. The preform microplate 200 may then be subsequently reformed to reduce the thickness of particular areas, such as where thinner parts may be desired (e.g. the well walls). In other embodiments, material may be added to the preform microplate 200 during the reforming step to increase the thickness of particular areas (e.g. the deck). In some embodiments, the greatest thickness in the microplate 100 may be located in a region of the deck 106 and/or the deck apron 106a.

In various embodiments, the preform microplate 200 has at least one well 202 having first well depth 222 that is shallower than the second well depth 122 of a corresponding well of the reformed microplate 100. A preform microplate 200 with a shallow well may allow for a greater fill pressure when forming the preform microplate 200 by injection molding, in at least certain embodiments. Greater fill pressure during injection molding may lead to the creation of a more repeatable microplate 100.

In some embodiments, the second well depth 122 of at least one well 102 of the reformed microplate 100 is greater than the first well depth 222 of a corresponding well 202 of the preform microplate 200. In some embodiments, the second well depth 122 of at least one well 102 of the reformed microplate 100 is substantially the same as, or less than, the first well depth 222 of a corresponding well 202 of the preform microplate 200. In the exemplary embodiments shown in FIGS. 3-7, the second well depth 122 of each well 102 of the reformed microplate 100 is greater than the first well depth 222 of each of the corresponding wells 202 of the preform microplate 200.

The wells 202 of the preform microplate 200 may have any shape suitable to be reformed into a well 102 configured to contain a fluid volume. Nonlimiting examples of shapes includes conical, frustoconical, rounded conical, right or oblique pyramidal, right or oblique frustopyramidal, cylindrical, cylindrical with a rounded end, right or oblique prism shaped, uniform or nonuniform prism shaped, bullet-shaped, and combinations thereof. In various embodiments, at least one well 202 has at least one plane of symmetry. In some embodiments, the at least one plane of symmetry includes a major axis of the well 202. In some embodiments, at least one well 202 is radially symmetric about the major axis of the well 202. Other embodiments include at least one well 202 that lacks a plane of symmetry. In some embodiments, the well 202 has a cross-section taken along a plane substantially perpendicular to the major axis of the well that is substantially the same shape throughout the depth of the well 202. In other embodiments, the well 202 has a cross-section taken along a plane substantially perpendicular to the major axis of the well that varies throughout the depth of the well 202. In some embodiments, the well 202 has a circular cross-section taken along a plane substantially perpendicular to the major axis of the well, as shown in FIG. 3.

The well bottom 204 of the preform microplate 200 may likewise have any shape suitable for being reformed into a well bottom 104. In some embodiments, the well bottom 204 is curved. In other embodiments, the well bottom 204 is flat. In still other embodiments, the well bottom 204 is pointed, for example a cone shape, a shallow cone shape, or a truncated cone shape. In the embodiment shown in FIG. 3, for example, each well 202 has a substantially cylindrical well wall 205 with a substantially shallow conical well bottom 204.

In some embodiments, the size and/or shape of the well 202 including the well wall 205 and/or the well bottom 204 can influence the wall thickness profile of a corresponding well 102 of the microplate 100 after the reforming process. During the reforming of the wells, the dimensions of the deck may also change. In various embodiments, the wells 102 of the reformed microplate 100 may be similarly shaped as described for wells 202.

In various embodiments, reforming a preform microplate 200 may allow the reformed microplate 100 to have at least one well 102 having a well wall 105 with a thickness 125 that is thinner than what is achievable with conventional microplate preparation techniques, such as molding.

Additionally, conventional molding techniques may result in defects such as weak areas and/or knit lines that are artifacts of the molding process. Reforming the preform microplate 200 may repair these defects, or reduce the impact of these defects on the structural integrity and/or performance of the reformed microplate 100.

Further, in at least certain embodiments, a reformed microplate 100 having wells with thinner walls as described herein may use less material than microplates prepared according to conventional processes.

As used herein, the term “well opening” is meant to indicate the region of the well a furthest distance from the well bottom, in a major plane substantially parallel to the top surface of the deck, to define the entrance to the interior volume of the well.

As used herein, the term “well bottom” is meant to indicate that portion of the well wall that is located at the farthest region of the well from the well opening.

As used herein, the terms “first well depth” and “second well depth” are meant to refer to a length of the well as measured in a direction substantially perpendicular to the plane of the well deck, from the well opening to the well bottom.

As used herein, the phrase “wall thickness profile” is meant to include the thickness of the well wall including variability therein, such as variability in a well depth direction, and/or variability over at least one cross-section of the well taken substantially parallel to the major plane of the top surface of the deck.

As used herein, the singular forms “a,” “an” and “the” include plural referents unless the context clearly dictates otherwise. Thus, for example, reference to a “well” includes examples having two or more such “wells” unless the context clearly indicates otherwise.

As used herein, the term “at least one” means “one or more,” for example one, two, several, many, or all.

As used herein, the term “and/or” means at least one of the options, but can include more than one of the options, for example one, two, several, many, or all of the options.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a microplate comprising polypropylene include embodiments where a microplate consists of polypropylene and embodiments where a microplate consists essentially of polypropylene.

It will be apparent to those skilled in the art that various modifications and variations can be made to the present invention without departing from the spirit and scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

We claim:

1. A method of forming a microplate, comprising:
providing a preform microplate comprising a deck and a plurality of wells, each well of the plurality of wells having a first depth and a first wall thickness, and
reforming at least one well of the plurality of wells to provide a microplate comprising at least one well having a second depth and a second wall thickness,
wherein at least one of the second depth is greater than the first depth, or the second wall thickness is less than the first wall thickness.

2. The method according to claim 1, wherein the second depth is greater than the first depth, and the second wall thickness is less than the first wall thickness.

3. The method according to claim 1, wherein providing a preform microplate comprises forming a preform microplate.

4. The method according to claim 3, wherein forming a preform microplate comprises a process chosen from injection molding, drawing by at least one of a plurality of core pins and a cavity block, and combinations thereof.

5. The method according to claim 1, wherein the reforming comprises drawing by at least one of a plurality of core pins and a cavity block.

6. The method according to claim 5, wherein the cavity block comprises at least one vent.

7. The method according to claim 5, wherein the drawing comprises forming a vacuum.

8. The method according to claim 5, wherein at least one of the plurality of core pins and the cavity block is heated.

9. The method according to claim 1, further comprising coining or pressing the deck.

10. The method according to claim 1, wherein the microplate is a PCR plate.

11. The method according to claim 1, wherein the microplate comprises polypropylene.

12. The method according to claim 1, wherein the microplate comprises an optically transparent material.

13. The method according to claim 1, wherein the microplate has a lower stress than the preform microplate.

14. The method according to claim 1, wherein at least one well of the plurality of wells has a second wall thickness that is variable over the second depth.

15. The method according to claim 1, wherein the second wall thickness is substantially uniform throughout a substantial region of each well of the plurality of wells.

16. A microplate comprising,
a deck having a deck thickness, and
a plurality of wells formed in the deck, each well of the plurality of wells having a depth and a wall thickness,
wherein at least one well of the plurality of wells has a wall thickness that is less than the deck thickness.

17. The microplate according to claim 16, wherein the microplate is a PCR plate.

18. The microplate according to claim 16, wherein the deck thickness ranges from greater than 1 to about 10 times the wall thickness.

19. The microplate according to claim 16, wherein the wall thickness is substantially uniform throughout a substantial region of each well of the plurality of wells.

20. The microplate according to claim 16, wherein the deck and the plurality of wells are integrally formed.

21. The microplate according to claim 16, wherein at least one of the deck and the plurality of wells comprises polypropylene.

22. The microplate according to claim 16, wherein at least one of the deck and the plurality of wells comprises an optically transparent material.

23. A microplate comprising,
a deck, and
a plurality of wells formed in the deck, each well of the plurality of wells having a depth and a wall thickness,
wherein at least one well of the plurality of wells has a wall thickness that is variable over the well depth.

24. A preform microplate comprising,
a deck having a deck thickness, and
a plurality of wells formed in the deck, each well of the plurality of wells having a depth and a wall thickness,
wherein at least one well of the plurality of wells has a wall thickness that is substantially equal to the deck thickness, and
wherein at least one well of the plurality of wells comprises:
a substantially cylindrical side wall, and
a well bottom having a conical shape, wherein a height of the conical shape is less than a diameter of the conical shape.
